(19) United States
(12) Patent Application Publication
(10) Pub. No.: US 2026/0113640 A1
(43) Pub. Date: Apr. 23, 2026

(54) FORECASTING NETWORK COVERAGE

(71) Applicant: T-MOBILE INNOVATIONS LLC, Overland Park, KS (US)

(72) Inventors: Gregory Wade PRESTRIDGE, Olathe, KS (US); Zaheer Mohammed Siddique, Overland Park, KS (US)

(21) Appl. No.: 18/921,148

(22) Filed: Oct. 21, 2024

(51) Int. Cl. H04W 16/18; H04W 16/22; H04W 24/08; H04W 84/06

(52) U.S. Cl. CPC H04W 16/18; H04W 16/22; H04W 24/08; H04W 84/06

(57) ABSTRACT

Methods, media, and systems are provided for forecasting network coverage. In particular, aspects described herein provide forecasted network coverage for non-terrestrial nodes of a telecommunication network (e.g., satellites). The forecasted network coverage can be predicated for specific locations at specific points in time. Thus, network coverage can proactively be identified for a region at a later date.

### SUMMARY

A high-level overview of various aspects of the invention are provided here for that reason, to provide an overview of the disclosure and to introduce a selection of concepts that are further described in the detailed-description section below. This summary is not intended to identify key features or essential features of the claimed subject matter, nor is it intended to be used as an aid in isolation to determine the scope of the claimed subject matter. The present disclosure is directed, in part, to forecasting network coverage in a carrier agnostic manner, substantially as shown in and/or described in connection with at least one of the figures, and as set forth more completely in the claims.

In aspects set forth herein, and at a high level, the technology described herein relates to carrier agnostic network coverage forecasting. In aspects, network coverage forecasting can be performed in real-time or in advance. Network coverage forecasting can be performed for terrestrial or non-terrestrial nodes of a telecommunication network. By forecasting the coverage and making the forecast data available to a device/user, devices can intelligently attach to other nodes of a system in order to maintain desired service. In other words, if a node is forecasted to experience decreased signal strength (e.g., degradation in service), the device can plan to terminate a session with that node and attach to a different node forecasted to have a higher likelihood of maintained service.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, wherein:

FIG. 1 depicts an example operating environment for forecasting network coverage in a wireless telecommunication network, in accordance with aspects herein;

FIG. 2 illustrates an example flowchart for forecasting network coverage, in accordance with aspects herein;

FIG. 3 illustrates another example flowchart for forecasting network coverage, in accordance with aspects herein; and

FIG. 4 depicts an example computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms may be found in Newton's Telecom Dictionary, (e.g., 32d Edition, 2022).

In addition, words such as “a” and “an,” unless otherwise indicated to the contrary, may also include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. Further, the term “some” may refer to “one or more.” Additionally, an element in the singular may refer to “one or more.”

The term “combination” (e.g., a combination thereof, combinations thereof) may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

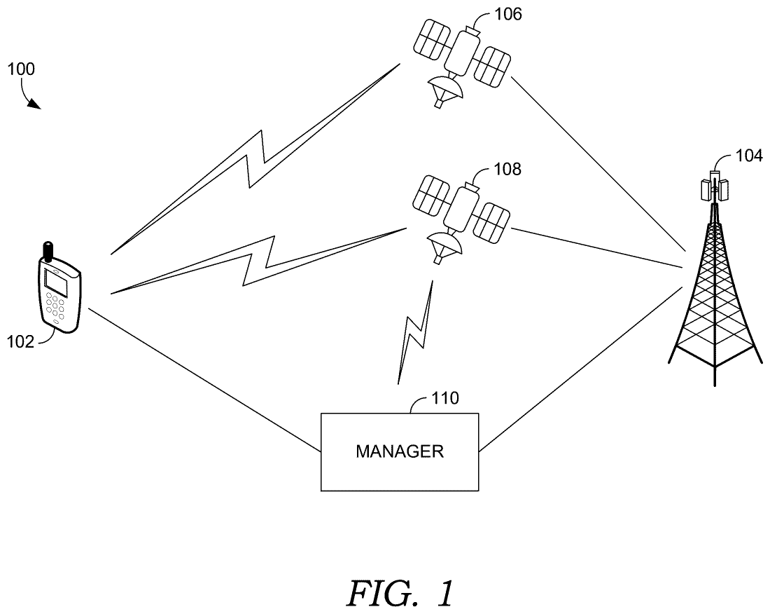

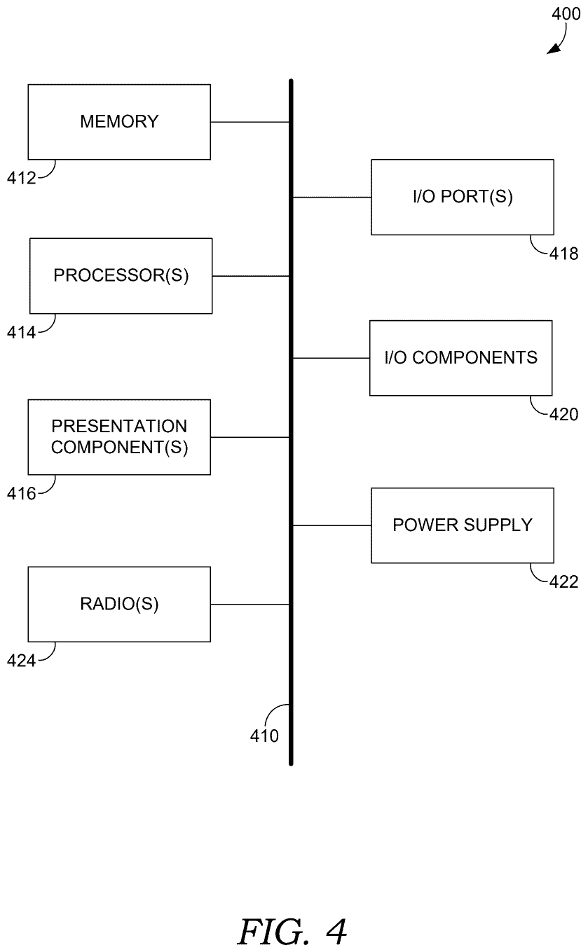

Additionally, a “user device,” as used herein, is a device that has the capability of using a wireless communications network, and may also be referred to as a “computing device,” “mobile device,” “user equipment,” “wireless communication device,” “device,” or “UE.” A user device, in some aspects, may take on a variety of forms, such as a PC, a laptop computer, a tablet, a mobile phone, a PDA, a server, or any other device that is capable of communicating with other devices (e.g., by transmitting or receiving a signal) using a wireless communication. A user device may be, in an embodiment, similar to user device 102 described herein with respect to FIG. 1. A user device may also be, in another embodiment, similar to user device 400, described herein with respect to FIG. 4.

A user device may additionally include internet-of-things devices, such as one or more of the following: a sensor, controller (e.g., a lighting controller, a thermostat), appliances (e.g., a smart refrigerator, a smart air conditioner, and a smart alarm system), other internet-of-things devices, or one or more combinations thereof. Internet-of-things devices may be stationary, mobile, or both. In some aspects, the user device is associated with a vehicle (e.g., a video system in a car capable of receiving media content stored by a media device in a house when coupled to the media device via a local area network). In some aspects, the user device comprises a medical device, a location monitor, a clock, other wireless communication devices, or one or more combinations thereof.

In aspects, a user device discussed herein may be configured to communicate using one or more of 3G, 4G (e.g., LTE), 5G, 6G, another generation communication system, or one or more combinations thereof. In some aspects, the user device has a radio that connects with a 4G base station but is not capable of connecting with a higher generation communication system. In some aspects, the user device has components to establish a 5G connection with a 5G gNB, and to be served according to 5G over that connection. In some aspects, the user device may be an E-UTRAN New Radio-Dual Connectivity (ENDC) device.

“Wireless telecommunication services” refer to the transfer of information without the use of an electrical conductor as the transferring medium. Wireless telecommunication services may be provided by one or more telecommunication network providers. Wireless telecommunication services may include, but are not limited to, the transfer of information via radio waves (e.g., Bluetooth®), satellite communication, infrared communication, microwave communication, Wi-Fi, mmWave communication, and mobile communication. Embodiments of the present technology may be used with different wireless telecommunication technologies or standards, including, but not limited to, CDMA 1xAdvanced, GPRS, Ev-DO, TDMA, GSM, WiMax technology, LTE, LTE Advanced, other technologies and standards, or one or more combinations thereof.

A “network” providing the wireless telecommunication services may be a telecommunication network(s), or a portion thereof. A telecommunication network might include an array of devices or components (e.g., one or more base stations). The network can include multiple networks, and the network can be a network of networks. In embodiments, the network is a core network, such as an evolved packet core, which may include at least one mobility management entity, at least one serving gateway, and at least one Packet Data Network gateway. The mobility management entity may manage non-access stratum (e.g., control plane) functions such as mobility, authentication, and bearer management for other devices associated with the evolved packet core.

In some aspects, a network can connect one or more user devices to a corresponding immediate service provider for services such as 5G and LTE, for example. In aspects, the network provides wireless telecommunication services comprising one or more of a voice service, a message service (e.g., SMS messages, MMS messages, instant messaging messages, an EMS service messages), a data service, other types of wireless telecommunication services, or one or more combinations thereof, to user devices or corresponding users that are registered or subscribed to a telecommunication service provider to utilize the one or more services. The network can comprise any communication network providing voice, message, or data service(s), such as, for example, a 1x circuit voice, a 3G network (e.g., CDMA, CDMA2000, WCDMA, GSM, UMTS), a 4G network (WiMAX, LTE, HSDPA), a 5G network, a 6G network, another generation network, or one or more combinations thereof.

Components of the network, such as terminals, links, and nodes (as well as other components), can provide connectivity in various implementations. For example, components of the network may include core network nodes, relay devices, integrated access and backhaul nodes, macro eNBs, small cell eNBs, gNBs, relay base stations, other network components, or one or more combinations thereof. The network may interface with one or more base stations through one or more wired or wireless backhauls. As such, the one or more base stations may communicate to devices via the network or directly. Furthermore, user devices can utilize the network to communicate with other devices (e.g., a user device(s), a server(s), etc.) through the one or more base stations.

As used herein, the term “base station” (used for providing UEs with access to the telecommunication services) or “node” generally refers to one or more base stations, nodes, RRUs control components, and the like (configured to provide a wireless interface between a wired network and a wirelessly connected user device). A base station may comprise one or more nodes (e.g., eNB, gNB, and the like) that are configured to communicate with user devices. In some aspects, the base station may include one or more band pass filters, radios, antenna arrays, power amplifiers, transmitters/receivers, digital signal processors, control electronics, GPS equipment, and the like.

For example, the base station may refer to a base transceiver station, a radio base station, an access point, a radio transceiver, a NodeB, an eNB, a gNB, a Home NodeB, a Home eNodeB, another type base station, or one or more combinations thereof. A node corresponding to the base station may comprise one or more of a macro base station, a small cell or femtocell base station, a relay base station, another type of base station, or one or more combinations thereof. In aspects, the base station may be configured as FD-MIMO, massive MIMO, MU-MIMO, cooperative MIMO, 3G, 4G, 5G, another generation communication system, or one or more combinations thereof. In addition, the base station may operate in an extremely high frequency region of the spectrum (e.g., from 30 GHz to 300 GHz), also known as the millimeter band.

Aspects of the technology described herein may be embodied as, among other things, a method, system, or computer-program product. Accordingly, aspects may take the form of a hardware embodiment, or an aspect combining software and hardware. An aspect that takes the form of a computer-program product can include computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal (e.g., a modulated data signal referring to a propagated signal that has one or more of its characteristics set or changed to encode information in the signal). Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, users of a telecommunication network may experience situations where they lose service upon entering an area of low service capabilities. For instance, a user embarking on a hike to a camp site may plan to camp at a location with no service from terrestrial nodes of a telecommunication network. No service is not desirable for wireless users as they are unable to connect with others, for instance, in case of an emergency. With the increased applicability of non-terrestrial nodes (e.g., satellites), devices may be able to connect to non-terrestrial nodes for service in situations where terrestrial nodes are unavailable. However, non-terrestrial nodes are, by their nature, dynamic. They move across the sky constantly and are not in the same spot regularly in order to rely on the non-terrestrial node for reliable service at all times. Put simply, non-terrestrial nodes are moving eNodeB's. Satellite movement may be available publicly but this is not sufficient in order to plan or predict availability of the satellite/non-terrestrial node for users. Additional proprietary data that is not available can be used to enhance forecasting of network coverage. For instance, satellite broadcasting information including elevation angles of the satellites and beams projected by the satellites would impact the signal strength provided by the node. Each satellite can broadcast multiple beams (i.e., they may each broadcast a different number of beams) and may be at different angles. Simply identifying a location of the satellite is not very helpful to forecast network coverage.

The dynamic nature of non-terrestrial nodes makes it such that a non-terrestrial node may provide coverage at a first location at a first day but will not provide coverage at the first location at a second day. Alternatively, a non-terrestrial node may provide coverage in the morning at a location but not in the evening in the same location. This makes it difficult to rely on the non-terrestrial node for coverage. Additionally, the non-terrestrial nodes are inherently low-bandwidth nodes so a network would want to limit signaling back and forth between devices and non-terrestrial nodes only to find out that the non-terrestrial node does not offer the coverage necessary for a specific device at a specific location.

In aspects herein, network coverage forecasting is provided that enables intelligent attachment of devices to non-terrestrial nodes to provide coverage where terrestrial nodes otherwise cannot (e.g., areas of low or no signal for terrestrial nodes). Aspects herein allow for network coverage forecasting in advance or in real-time. In specific aspects, the forecasting is provided in advance to a user equipment (UE). This may be at the request of a UE (e.g., a UE requests coverage forecast data from a network), an automatic action by the network (e.g., the network can identify that the UE is directionally headed to an area of low or no coverage), automatic action by the device (e.g., the device identifies that a degradation in network coverage is occurring), and the like. Any of these may trigger a network coverage forecast to be performed (e.g., in real-time), accessed (from storage on a UE), or communicated (from a network to a UE).

The network coverage can be forecasted using broadcasting information for non-terrestrial nodes, terrestrial nodes, or the like. Broadcasting information may comprise an elevation of a node, an angle/tilt of a node, a travel speed of a node, a location of a node, a number of beams emitted by a node, and the like. This information can be utilized to prioritize nodes in a network. For instance, if a first node will have a higher signal strength than a second node at a first location at a first time, then the first node will be assigned a higher prioritization score than the second node. However, because of the dynamic nature of non-terrestrial nodes, the prioritization score of the first node may be lower than that of the second node at the first location at a second time different from the first time (e.g., morning versus evening, cloudy versus sunny sky, etc.).

The forecast information along with the prioritization scores can be stored on a network, a UE, or a combination thereof. The forecast information can be updated at predetermined time intervals (e.g., daily, weekly, etc.). Once updated, an updated network coverage forecast can be communicated to any relevant UEs, saved on the network, and the like.

In the event a service is degrading, the prioritization scores may be utilized by, for instance, the UE, to identify a node to which the UE can attach to regain service. The UE would, in that instance, attach to a node having the highest prioritization score based on the network forecast data. The UE would, as a result, terminate a session with the current node experiencing a degradation in service (if the connection still exists).

There are many advantages to the aspects provided herein, for example being able to allow determination and usage of network coverage forecasts in situations of low or no service ensures that communication options are identifiable by users in situations where they otherwise may not be identified. Additionally, by utilizing satellites (i.e., non-terrestrial nodes) for aspects, a low bandwidth option is provided that results in high throughput; in other words, a larger number of users may utilize a text-only network option in emergency situations due to the lower bandwidth of a satellite node. This may provide more resources to the network, reducing congestion and improving overall performance. There may also be an enhanced user experience since they can access telecommunication services when they otherwise would not have been able to communicate.

In a first aspect, method for forecasting network coverage is provided. The method comprises identifying a degradation in network coverage at a location for a first node; accessing forecasted network coverage at the location for at least a second node and a third node; based on the forecasted network coverage at the location, prioritizing at least the second node and the third node for the location; and attaching to one of the second node or the third node having a higher prioritization score.

In a second aspect, a system is provided for forecasting network coverage. The system comprises one or more processors and computer memory storing computer-usable instructions that, when executed by the one or more processors, perform operations comprising: identifying a degradation in network coverage at a location for a first node; accessing forecasted network coverage at the location for at least a second node and a third node; based on the forecasted network coverage at the location, prioritizing at least the second node and the third node for the location; and attaching to one of the second node or the third node having a higher prioritization score.

In a third aspect, one or more non-transitory computer storage media having computer-executable instructions embodied thereon is provided, that when executed by at least one processor, cause the at least one processor to perform a method. The method includes, identifying a degradation in terrestrial network coverage at a location associated with a first node; accessing forecasted network coverage for non-terrestrial nodes at the location; based on the forecasted network coverage for non-terrestrial nodes at the location, identifying a signal strength of each non-terrestrial node at the location; prioritizing the signal strength of each non-terrestrial node at the location; identifying a first non-terrestrial node having a higher signal strength than each of the other non-terrestrial nodes; and attaching to the first non-terrestrial node.

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement to any one or combination of components illustrated.

More specifically, FIG. 1 depicts a system for forecasting network coverage within a wireless telecommunication network. The system includes components and interactions between the manager 110 and network nodes to a UE 102. Network environment 100 includes node 104 (e.g., terrestrial node) and nodes 106, and 108 (e.g., non-terrestrial nodes or satellites). While shown as a separate component in FIG. 1, manager 110 can be a stand-alone component, a network-integrated component, integrated into a node (e.g., nodes 104, 106, 108), or integrated into a UE (e.g., a native application of the UE, integrated into an operating system, etc.). In aspects herein, the manager 110 is identified as performing the intelligent actions (e.g., determining, identifying, attaching, etc.) but it should be understood that the manager 110 can perform those actions as a network component or a user device (UE) component. In aspects, the manager 110 is located within the UE 102 in an effort to reduce signaling at the network.

As mentioned, network environment 100 includes user device 102. In network environment 100, user device 102 may take on multiple forms, such as cameras, microphones, sensors, goggles, and glasses, to name a few, or any other device (such as the computing device (400) that communicates via wireless communications to interact with a telecommunication network.

In some aspects, the user device 102 may correspond to computing device 400 in FIG. 4. Thus, user device can include, for example, a display(s), a power source(s) (e.g., a battery), a data store(s), a speaker(s), memory, a buffer(s), a radio(s) and the like. In some implementations, for example, user device 102 comprises a wireless or mobile device with which a wireless telecommunication network(s) can be utilized for communication (e.g., voice and/or data communication). In this regard, the user device 102 can be any mobile computing device that communicates by way of a wireless network, for example, a 3G, 4G, 5G, 6G, LTE, CDMA, or any other type of network. In some cases, user device 102 in network environment 100 can optionally utilize one or more communication channels (not shown) to communicate with other computing devices (e.g., a mobile device(s), a server(s), a personal computer(s), etc.) through the nodes 104, 108, and 110. Nodes shown herein may be a gNodeB, eNodeB, non-terrestrial nodes (e.g., satellites), or the like.

The network environment 100 may be comprised of a telecommunication network(s) (not shown), or a portion thereof. A telecommunication network might include an array of devices or components (e.g., one or more base stations), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure.

The network environment 100 further comprises manager 110. The manager 110 is configured to perform the aspects described herein to forecast network coverage. The manager 110, for instance, can identify a degradation in existing service, access forecasted network coverage, generate forecasted network coverage, prioritize available nodes based on the network coverage forecast, attach a UE to a different node using the prioritization of nodes in the forecast, terminate sessions to other nodes, and the like.

In aspects, a UE 102 may experience a degradation in service while attached to node 104 (i.e., a terrestrial node). This may be due to the UE 102 moving into an area that is not sufficiently covered by terrestrial nodes (e.g., hiking destinations, remote areas, etc.). The manager 110 can identify the degradation in service. In other aspects, the UE 102 can identify the degradation in service.

Alternatively, the UE 102 may proactively request a network coverage forecast for a specific area or the UE 102 can proactively generate a network coverage forecast for a specific area (e.g., a known trip to a remote area is coming up).

Whether proactively requested/generated or requested due to a degradation in service, a network coverage forecast is accessed by the UE 102 or manager 110. Again, the manager 110 may be housed on the UE 102. The network coverage forecast can include coverage predictions for terrestrial nodes (if any available), non-terrestrial nodes, or a combination thereof. Based on the forecasted network coverage, the manager 110 or the UE 102 can prioritize available nodes. The prioritization can be based on a prioritization score assigned using the forecasted network coverage. For instance, if a node is anticipated to have better coverage (e.g., higher signal strength) than another node, then the node with the predicted higher signal strength is assigned a higher prioritization score. A node having a highest prioritization score (i.e., a prioritization score higher than any other node in the network coverage forecast) then that node having the highest prioritization score is identified as the node to which the UE 102 should attach. The attachment to the node having the highest prioritization score may be a result of a degradation in service and, as such, happen in real-time. In aspects, the attachment to the node having the highest prioritization score may be a planned event at a later time. In other words, the UE 102 can generate an instruction to attach to Node A on a specific date at a specific time. For example, if satellite A is a higher prioritization score at the present moment but satellite B has a higher prioritization score 15 minutes from now, the UE 102 can disconnect from satellite A and connect to satellite B without any additional input, relying solely on the network coverage forecast. The prioritization, along with the network coverage forecast, is dynamic and can be updated and pushed to a device as changes are made or at predetermined time intervals.

By utilizing the UE 102 (or the manager 110 on the UE 102) to perform the methods described herein, network signaling is decreased. Thus, network resources are made available to the network that otherwise would be consumed with signaling to determine an available node for the UE 102. Additionally, non-terrestrial nodes are low-bandwidth nodes and, thus, it is desirable to reduce signaling with non-terrestrial nodes whenever possible in order to conserve resources for service.

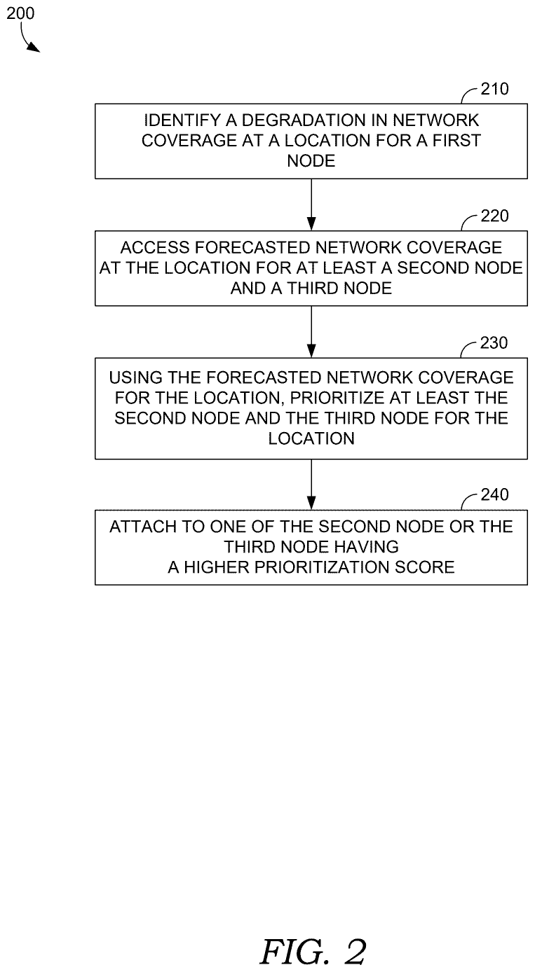

FIG. 2 illustrates an example flowchart of a method 200 for forecasting network coverage, in accordance with aspects herein. Initially, at block 210, a degradation in network coverage is identified at a location for a first base station or node. At block 220, a forecasted network coverage is accessed for the location for at least a second node and a third node. Using the forecasted network coverage for the location, at least the second node and third node for the location are prioritized at block 230. At block 240, an attachment to one of the second node or the third node having a higher prioritization score is instructed.

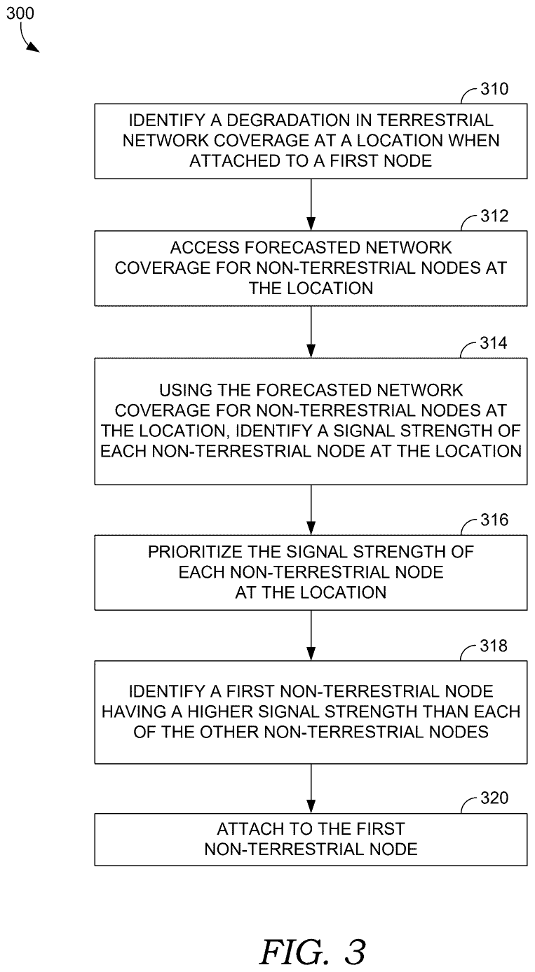

Turning now to FIG. 3, FIG. 3 illustrates another example flowchart of a method 300 for forecasting network coverage, in accordance with aspects herein. Initially, at block 310, a degradation in terrestrial network coverage when attached to a first node is identified. Forecasted network coverage for non-terrestrial nodes at the location is accessed at block 312. Using the forecasted network coverage for the non-terrestrial nodes at the location, a signal strength of each non-terrestrial node at the location is identified at block 314. The signal strength of each non-terrestrial node at the location is prioritized at block 316. At block 318, a first non-terrestrial node having a higher signal strength than each of the other non-terrestrial nodes is identified. An attachment to the first non-terrestrial node is executed at block 320.

Having described the example embodiments discussed above of the presently disclosed technology, an example operating environment of an example user device (e.g., user device 102 of FIG. 1) is described below with respect to FIG. 4. User device 400 is but one example of a suitable computing environment, and is not intended to suggest any particular limitation as to the scope of use or functionality of the technology disclosed. Neither should user device 400 be interpreted as having any dependency or requirement relating to any particular component illustrated, or a particular combination of the components illustrated in FIG. 4.

As illustrated in FIG. 4, example user device 400 includes a bus 410 that directly or indirectly couples the following devices: memory 412, one or more processors 414, one or more presentation components 416, one or more input/output (I/O) ports 418, one or more I/O components 420, a power supply 422, and one or more radios 424.

Bus 410 represents what may be one or more busses (such as an address bus, data bus, or combination thereof). Although the various blocks of FIG. 4 are shown with lines for the sake of clarity, in reality, these blocks represent logical, not necessarily actual, components. For example, one may consider a presentation component, such as a display device, to be an I/O component. Also, processors have memory. Accordingly, FIG. 4 is merely illustrative of an exemplary user device that can be used in connection with one or more embodiments of the technology disclosed herein.

User device 400 can include a variety of computer-readable media. Computer-readable media can be any available media that can be accessed by user device 400 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by user device 400. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. One or more combinations of any of the above should also be included within the scope of computer-readable media.

Memory 412 includes computer storage media in the form of volatile and/or nonvolatile memory. The memory 412 may be removable, non-removable, or a combination thereof. Example hardware devices of memory 412 may include solid-state memory, hard drives, optical-disc drives, other hardware, or one or more combinations thereof. As indicated above, the computer storage media of the memory 412 may include RAM, Dynamic RAM, ROM, EEPROM, flash memory or other memory technology, CD-ROM, a cache memory, DVDs or other optical disk storage, magnetic cassettes, magnetic tape, magnetic disk storage or other magnetic storage devices, a short-term memory unit, a long-term memory unit, any other medium which can be used to store the desired information and which can be accessed by user device 400, or one or more combinations thereof.

The one or more processors 414 of user device 400 can read data from various entities, such as the memory 412 or the I/O component(s) 420. The one or more processors 414 may include, for example, one or more microprocessors, one or more CPUs, a digital signal processor, one or more cores, a host processor, a controller, a chip, a microchip, one or more circuits, a logic unit, an integrated circuit (IC), an application-specific IC (ASIC), any other suitable multi-purpose or specific processor or controller, or one or more combinations thereof. In addition, the one or more processors 414 can execute instructions, for example, of an operating system of the user device 400 or of one or more suitable applications.

The one or more presentation components 416 can present data indications via user device 400, another user device, or a combination thereof. Example presentation components 416 may include a display device, speaker, printing component, vibrating component, another type of presentation component, or one or more combinations thereof. In some embodiments, the one or more presentation components 416 may comprise one or more applications or services on a user device, across a plurality of user devices, or in the cloud. The one or more presentation components 416 can generate user interface features, such as graphics, buttons, sliders, menus, lists, prompts, charts, audio prompts, alerts, vibrations, pop-ups, notification-bar or status-bar items, in-app notifications, other user interface features, or one or more combinations thereof. For example, the one or more presentation components 416 can present a visualization that compares a plurality of inspections of one or more cores of a central processing unit and a visualization of each task of each of the plurality of inspections.

The one or more I/O ports 418 allow user device 400 to be logically coupled to other devices, including the one or more I/O components 420, some of which may be built in. Example I/O components 420 can include a microphone, joystick, game pad, satellite dish, scanner, printer, wireless device, and the like. The one or more I/O components 420 may, for example, provide a natural user interface (NUI) that processes air gestures, voice, or other physiological inputs generated by a user. In some instances, the inputs the user generates may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with the one or more presentation components 416 on the user device 400. In some embodiments, the user device 400 may be equipped with one or more imaging devices, such as one or more depth cameras, one or more stereoscopic cameras, one or more infrared cameras, one or more RGB cameras, another type of imaging device, or one or more combinations thereof, (e.g., for gesture detection and recognition). Additionally, the user device 400 may, additionally or alternatively, be equipped with accelerometers or gyroscopes that enable detection of motion. In some embodiments, the output of the accelerometers or gyroscopes may be provided to the one or more presentation components 416 of the user device 400 to render immersive augmented reality or virtual reality.

The power supply 422 of user device 400 may be implemented as one or more batteries or another power source for providing power to components of the user device 400. In embodiments, the power supply 422 can include an external power supply, such as an AC adapter or a powered docking cradle that supplements or recharges the one or more batteries. In aspects, the external power supply can override one or more batteries or another type of power source located within the user device 400.

Some embodiments of user device 400 may include one or more radios 424 (or similar wireless communication components). The one or more radios 424 can transmit, receive, or both transmit and receive signals for wireless communications. In embodiments, the user device 400 may be a wireless terminal adapted to receive communications and media over various wireless networks. User device 400 may communicate using the one or more radios 424 via one or more wireless protocols, such as code division multiple access (“CDMA”), global system for mobiles (“GSM”), time division multiple access (“TDMA”), another type of wireless protocol, or one or more combinations thereof. In embodiments, the wireless communications may include one or more short-range connections (e.g., a Wi-Fi® connection, a Bluetooth connection, a near-field communication connection), a long-range connection (e.g., CDMA, GPRS, GSM, TDMA, 802.16 protocols), or one or more combinations thereof. In some embodiments, the one or more radios 424 may facilitate communication via radio frequency signals, frames, blocks, transmission streams, packets, messages, data items, data, another type of wireless communication, or one or more combinations thereof. The one or more radios 424 may be capable of transmitting, receiving, or both transmitting and receiving wireless communications via mmWaves, FD-MIMO, massive MIMO, 3G, 4G, 5G, 6G, another type of Generation, 802.11 protocols and techniques, another type of wireless communication, or one or more combinations thereof.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software. For instance, various functions may be carried out by a processor executing instructions stored in memory. As such, other arrangements and elements (for example, machines, interfaces, functions, orders, and groupings of functions, and the like) can be used in addition to, or instead of, those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A method for forecasting network coverage, the method comprising:
identifying a degradation in network coverage at a location for a first node;
accessing forecasted network coverage at the location for at least a second node and a third node;
based on the forecasted network coverage at the location, prioritizing at least the second node and the third node for the location; and
attaching to one of the second node or the third node having a higher prioritization score.

2. The method according to claim 1, wherein the network coverage forecasted is non-terrestrial network coverage.

3. The method according to claim 1, wherein the degradation in network coverage is a degradation in terrestrial network coverage.

4. The method according to claim 1, wherein the degradation in network coverage is indicated by a decreased signal strength.

5. The method according to claim 1, wherein the first node is an eNodeB or a gNodeB.

6. The method according to claim 1, wherein the second node and the third node are non-terrestrial nodes.

7. The method according to claim 6, wherein the non-terrestrial node is a satellite.

8. The method according to claim 1, wherein the prioritization score is based on signal strength of a node.

9. The method according to claim 1, wherein the prioritization score is based on topology of the location.

10. The method according to claim 1, further comprising terminating a session with the first node.

11. A system for forecasting network coverage, the system comprising:
one or more processors; and
computer memory storing computer-usable instructions that, when executed by the one or more processors, perform operations comprising:
identifying a degradation in network coverage at a location for a first node;
accessing forecasted network coverage at the location for at least a second node and a third node;
based on the forecasted network coverage at the location, prioritizing at least the second node and the third node for the location; and
attaching to one of the second node or the third node having a higher prioritization score.

12. The system according to claim 11, wherein the network coverage forecasted is non-terrestrial network coverage.

13. The system according to claim 11, wherein the degradation in network coverage is a degradation in terrestrial network coverage, and wherein the degradation in network coverage is indicated by a decreased signal strength.

14. The system according to claim 11, wherein the first node is an eNodeB or a gNodeB.

15. The system according to claim 11, wherein the second node and the third node are non-terrestrial nodes, and wherein the non-terrestrial nodes are satellites.

16. The system according to claim 11, wherein the operations further comprise terminating a session with the first node.

17. One or more non-transitory computer storage media having computer-executable instructions embodied thereon, that when executed by at least one processor, cause the at least one processor to perform a method comprising:
identifying a degradation in terrestrial network coverage at a location associated with a first node;
accessing forecasted network coverage for non-terrestrial nodes at the location;
based on the forecasted network coverage for non-terrestrial nodes at the location, identifying a signal strength of each non-terrestrial node at the location;
prioritizing the signal strength of each non-terrestrial node at the location;
identifying a first non-terrestrial node having a higher signal strength than each of the other non-terrestrial nodes; and
attaching to the first non-terrestrial node.

18. The one or more non-transitory computer storage media of claim 17, wherein the method further comprises predicting network coverage for the non-terrestrial nodes at a later time based on the forecasted network coverage for non-terrestrial nodes.

19. The one or more non-transitory computer storage media of claim 18, further comprising determining a second-terrestrial node to attach to at the later time based on the predicted network coverage.

20. The one or more non-transitory computer storage media of claim 17, wherein the method further comprises terminating a session with the first node.
